(19) United States
(12) Patent Application Publication
(10) Pub. No.: US 2008/0255734 A1
(43) Pub. Date: Oct. 16, 2008

(54) SYSTEM AND METHOD FOR CONTROLLING A VEHICLE SEAT

(76) Inventors: Dmitry A. Altshuller, Moreno Valley, CA (US); Edgar Khachatryan, Valley Village, CA (US); Ary Geuvdjelian, Tarzana, CA (US)

Correspondence Address: CHRISTIE, PARKER & HALE, LLP, PO BOX 7068, PASADENA, CA, 91109-7068, US

(21) Appl. No.: 11/735,228

(22) Filed: Apr. 13, 2007

(51) Int. Cl. G05D 3/00; A47C 7/62

(52) U.S. Cl. 701/49; 297/217.3

(57) ABSTRACT

A method of controlling a vehicle seat includes determining a trajectory between a first position of the seat and the second position of the seat, determining a torque to move the seat along the trajectory with velocity profile along the trajectory, and applying the torque to the seat to move the seat between the first position and a second position along the trajectory.

### BACKGROUND

The present application is related to vehicle seats, and in particular, to a system and method for controlling an airplane seat.

Modern airplane seats, and in particular, seats in the premium sections of passenger airplane are powered and adjustable between a number of seating positions. Some seats may be adjustable from an upright position to a reclined position, while others can recline to a substantially flat position in order to function as a bed. Additionally, some airplane seats have a head rest and a foot rest that can be adjusted to provide a comfortable position for each passenger. The various adjustable features of the seat are accessible and controllable with a passenger control unit, which may be a keyboard-type of input device with a display. The passenger control unit may also provide the passenger with the ability to adjust the environmental conditions around the seat, such as lighting, temperature and the like. Furthermore, the passenger control unit can also allow the passenger to operate various entertainment devices and features associated with the seat.

When a seat is moved from one position to another, as may be requested by a passenger through the passenger control unit, the entire seat and/or parts of the seat are moved to position the seat in the requested position. For example, if the passenger requests that a seat be placed in the reclined position, the entire seat may move horizontally or rotate, while the backrest and the leg rest rotate to provide a more flat seat configuration. The seat may have a controller that performs such movements either in a particular sequence or simultaneously.

The speed of the seat and seat parts at the beginning of the motion and at the end of the motion are zero. The actuators that facilitate the motion of the seat typically apply a constant torque to the seat or the seat parts from the time when motion begins until the time the motion ends. Accordingly, a passenger can experience abrupt initial movement of the seat and an abrupt end to such movement when the seat or the seat parts reach a desired position. Furthermore, the motion of various seat parts may not be coordinated to smoothly transition the seat from one position to another.

Based on the above, there is a need for a control method and system that can provide trajectory planning for a seat and seat parts from one position to another and control the motion of the seat through the planned trajectory.

### SUMMARY

In accordance with an aspect of the disclosure, a method of controlling a vehicle seat includes determining a trajectory between a first position of the seat and the second position of the seat, determining a torque to move the seat along the desired trajectory with a velocity profile along the desired trajectory, and applying the torque to the seat to move the seat between the first position and a second position along the desired trajectory.

In accordance with another aspect of the disclosure, a method of controlling a vehicle seat includes receiving a request to move the seat from a first position to a second position, sensing a position corresponding to an actual position of the seat, determining a trajectory between the first position and the second position, the trajectory including a plurality of seat positions, determining a torque to move the seat from the first position along the trajectory toward the second position based on any difference between the sensed position and a one of the plurality of seat positions along the trajectory corresponding to the sensed position, and applying the torque to the seat to move the seat.

In accordance with another aspect of the disclosure, a control system for a vehicle seat includes at least one sensor configured to provide a sensed position corresponding to an actual seat position, and a main controller configured to receive a request for a second seat position different from a first seat position, the controller configured to determine a trajectory for the seat between the first seat position and the second seat position. The main controller is configured to determine a torque to move the seat along the trajectory toward the second seat position based on any difference between the sensed position and a seat position along the trajectory corresponding to the sensed position.

In accordance with another aspect of the disclosure, a vehicle seat includes a seat having at least one moveable part and configured to be moveable between a plurality of seat positions, at least one sensor configured to provide a sensed position corresponding to an actual seat position, an actuator coupled to the at least one moveable part and configured to move the seat between the plurality of seat positions, and a main controller configured to receive a request for a second seat position different from a first seat position, the controller configured to determine a trajectory for the seat between the first seat position and the second seat position. The main controller is configured to operate the actuator to move the seat along the trajectory toward the second seat position based on any difference between the sensed position and a seat position along the trajectory corresponding to the sensed position.

### BRIEF DESCRIPTION OF THE DRAWINGS

FIG. 1 shows a control method for controlling a vehicle seat according to the present disclosure.

FIG. 2 shows a schematic diagram of a vehicle seat.

FIG. 3 shows a schematic diagram of an operating system for a vehicle seat.

FIG. 4 shows a schematic diagram of another operating system for a vehicle seat.

FIG. 5 shows a schematic diagram of another operating system for a vehicle seat.

FIG. 6 shows one configuration of the vehicle seat of FIG. 2.

FIG. 7 shows a schematic diagram of the coupling between the parts of the seat configuration shown in FIG. 6.

FIG. 8 shows another configuration of the vehicle seat of FIG. 2

FIG. 9 shows another configuration of the vehicle seat of FIG. 2.

FIG. 10 shows a control method and system for controlling a vehicle seat according to the present disclosure.

FIG. 11 shows a control method and system for controlling according to the present disclosure for a vehicle seat having the operating system of FIG. 5.

### DETAILED DESCRIPTION

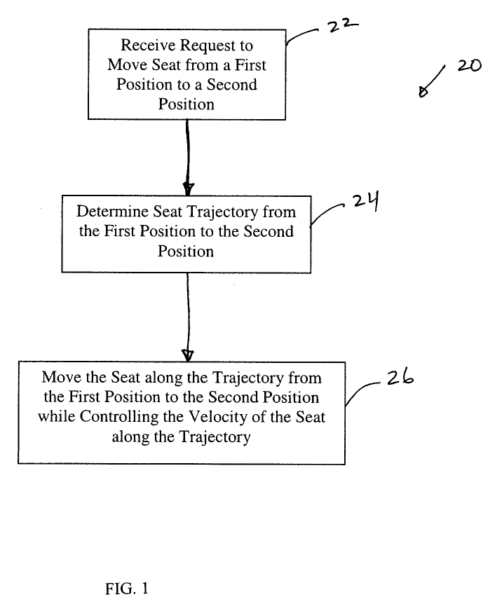

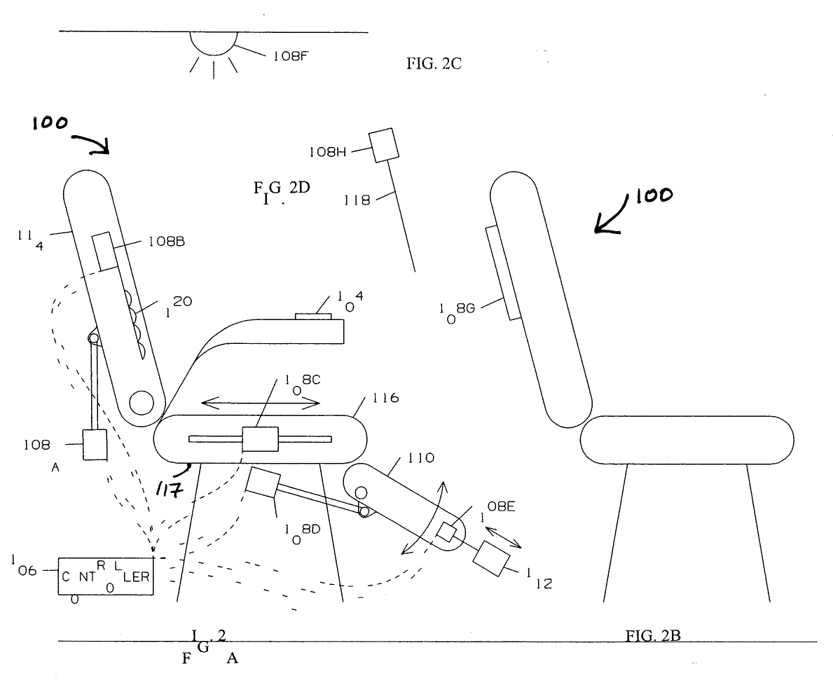

FIG. 1 illustrates a method 20 of controlling a powered vehicle seat 100 (shown in FIG. 2) according to the present disclosure. The method 20 includes receiving request at step 22 for moving the seat 100 from a first position, i.e., the current position, to a second position, i.e., a desired position. Moving the seat 100 as referred to herein refers to moving the entire seat and/or parts of the seat 100 in response to the input. The method 20 also includes determining a trajectory at step 24 for the movement of the seat 100 from the first position to the second position. At step 26, the method 20 includes moving the seat 100 along the trajectory while controlling the velocity of the motion along the trajectory.

FIG. 2 illustrates a powered vehicle seat 100, which includes a passenger control unit (PCU) 104 (e.g. a keyboard, display, etc.), a controller 106 and several actuators or other devices 108A-H. A passenger (not shown) sitting in the seat uses the keypad to adjust the seat position and associated devices. The keypad communicates with the controller which, in turn, controls the actuators. The seat controller drives the actuators which control various aspects of the seat. For example, an actuator 108D moves leg rest 110 that moves from a substantially vertical retracted position to a substantially horizontal, extended position. An actuator 108E moves a the foot rest 112, that moves from a substantially extended to a substantially retracted position. The foot rest 112 may extend from the leg rest 110. An actuator 108A moves the reclining back rest 114 (also referred to herein as the recliner) that moves from a substantially vertical position to a substantially horizontal position. An actuator 108C moves the seat pan 116. The entire seat 100 may be mounted on a spreader 117, which can provide the track for of the seat pan motion. An actuator 108H moves the privacy screen 118. A lumbar controller 108B drives/controls the lumbar bladder 120. In addition, each actuator may include one or more position determining components such as a transducer or sensor (not shown).

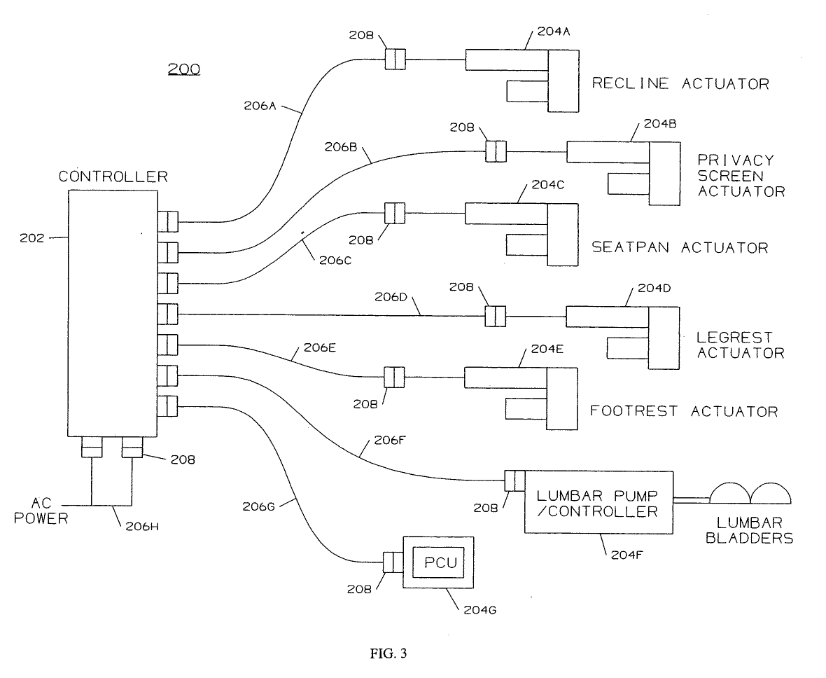

Referring to FIGS. 3-5, three seat operating systems are shown for the seat 100 and in which the control method 20 and system of the disclosure can be implemented. In the first seat operating system 200, as shown schematically in FIG. 3, all processing is performed in a controller 202. The controller thus directly controls the operation of each actuator or other devices 204A-F. For example, the controller generates control signals for each actuator and other devices and sends these signals to each actuator/device via separate connection leads 206A-G. In addition, any signals from sensors in the actuators are sent directly back to the controller.

In the second seat operating system 300, as schematically shown in FIG. 3, an actuator controller is incorporated into each actuator assembly 304A-E. The seat operating system 300 includes a main controller 302 which may coordinate the operation and position of all of the actuators. The main controller can send commands to each actuator controller over a common serial bus 306 (including leads 306A-G) to accomplish the desired actuation. Each actuator controller 308A-G controls the position of an associated actuator based on commands from the main controller 302. In response to a command for a given actuator, a corresponding actuator controller generates, within the actuator assembly, actuation signals for that actuator. Signals from sensors in an actuator are sent to the associated actuator controller in the actuator assembly. The actuator controller may use these sensor signals to verify the movement or position of the actuator.

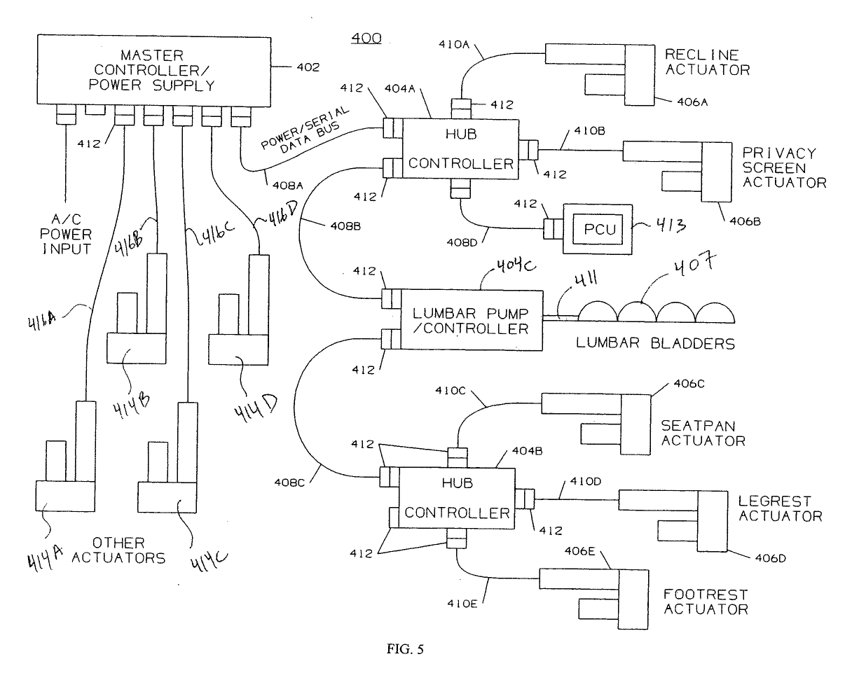

In the third seat operating system 400, as schematically shown in FIG. 5, a main controller 402 cooperates with several hub controllers 404A-404C to control several actuators 406A-406E and 407. Each of the hub controllers 404A-404C can control one or several seat devices 406A-406E and 407. The main controller 402 can send commands to each hub controller 404A-404C over a common serial bus 408 (including leads 408A-D) to accomplish the desired actuation. In response to commands for an associated actuator, a hub controller (e.g., hub controller 404A) generates actuation signals for the associated actuator (e.g., actuator 406B). The hub controller sends the actuation signals to the actuator via an associated connection lead (e.g., lead 410B). The hub controller can use a separate connection lead (e.g., lead 410A and 410B) to communicate with each actuator (e.g., actuators 406A and 406B). The lumbar pump/controller 404C can pneumatically communicate with the lumbar bladders 407 through a pneumatic conduit 411. The hub controllers 404A-404C may be used to control conventional actuators via conventional actuator signals. The hub controller may process the sensor signals to control the actuator. The hub controller also may send data derived from the sensor signals to the main controller.

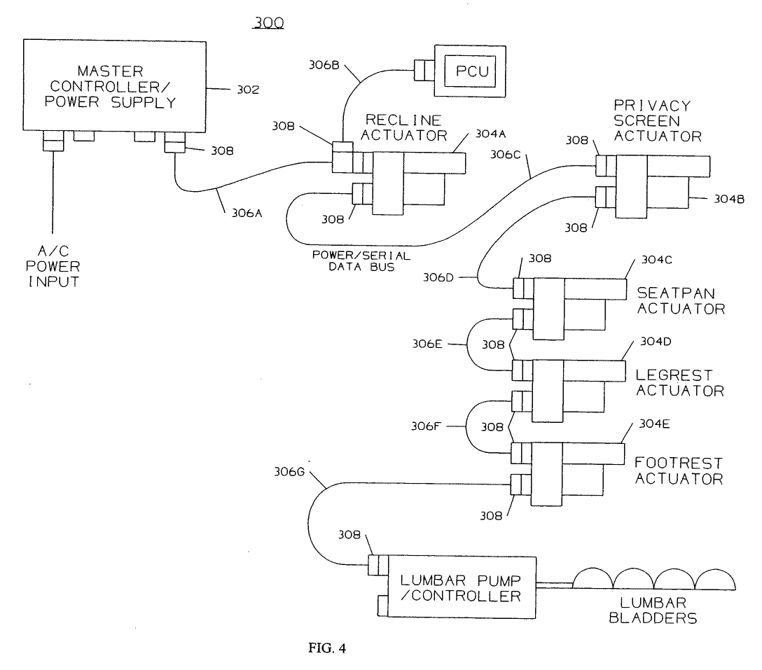

In the seat operating system 400 of FIG. 5, the main controller 402 can also directly operate four actuators 414A-D using cables 416A-D without any hub controllers. The actuators 414A-D may be the type that do not have an integrated controller so as to be directly controlled by the main controller 402. The actuators 414A-D may also be of the type that have integrated controllers which communicate with the main controller 402. The seat operating system 400 of FIG. 4 is described in detail in U.S. patent application Ser. No. 11/726,965, filed Mar. 21, 2007, the disclosure of which is incorporated herein by reference.

Referring to FIG. 1, in order to determine the trajectory at step 24, equations of motion of the seat 100 must be determined prior to implementing the control method 20 and system of the disclosure in any seat operating system. Deriving the equations of motion for dynamic systems are well known to those of ordinary skill in the art. The equations of motion can be derived for a general seat configuration so as to be applicable for a variety of seat configurations. The equations of motion can then be modified for application to particular seat configurations.

### Equations of Motion

In a general seat configuration, parts of the seat for which the linear and angular motion thereof are to be controlled are identified. One or more coordinate systems for the seat is then selected, which are used to mathematically formulate the linear and angular motion of each seat part. From the noted mathematical formulations, the number of independent state variables for deriving the equations of motion can be determined.

As is known to those of ordinary skill in the art, the independent state variables define the degrees of freedom (DOF) of the equations of motion. The state variables, which may be linear or angular, can be denoted q₁, q₂ . . . q_{N}, where N is the DOF of the system. Equations of motion can be derived using the Lagrangian formulation, which is defined by subtracting the potential energy of a system from the kinetic energy of the system. The kinetic and potential energy of each component can be formulated using the independent state variables. Accordingly, the kinetic and potential energies of the entire system can be denoted as T(q₁, q₂, . . . q_{N}, p₁, p₂, . . . p_{N}) and U(q₁, q₂, . . . q_{N}), respectively. In these functions q=(q₁, q₂, . . . q_{N}) and p=(p₁, p₂, . . . p_{N}) are the vectors of the so-called generalized coordinates and velocities (linear or angular), respectively. Thus, for unconstrained models pᵢ=\dot{q}ᵢ. Unconstrained models represent models where the state variables are decoupled, while constrained models refer to systems where one or more state variables may be coupled, i.e., dependent on each other. For example, two state variables may be coupled, e.g., by a mechanical linkage so as to represent one DOF. However, the coupling of the two state variables is then incorporated in the equations of motion through a mathematical constraint. Therefore, for models with constraints, the generalized coordinates and velocities are also related by the vector-matrix equation:

\dot{q}=V(q)p (2

Where V is a matrix, which mathematically defines the coupling of one or more state variables. The Lagrangian function is defined by:

L(q₁,q₂, . . . , q_{N},p¹,p₂, . . . p_{N})=T(q₁,q₂, . . . q_{N},p₁,p₂, . . . p_{N})−U(q₁,q₂, . . . q_{N}) (3)

The equations of motion in the Lagrangian formulation are:

$$\frac{d}{d t} \frac{\partial L}{\partial {p}_{i}} - \frac{\partial L}{\partial {q}_{i}} = {u}_{i} \qquad ( 4 )$$

In this set of N equations, uᵢ is the generalized torque affecting the state variable qᵢ and

$$\frac{d}{d t} ≡ {\sum }_{i} ( \frac{\partial }{\partial t} + {p}_{i} \frac{\partial }{\partial {q}_{i}} + {\dot{p}}_{i} \frac{\partial }{\partial {p}_{i}} ) \qquad ( 5 )$$

The vector-matrix form of the equations of motion is:

M(q)\ddot{q}+C(q,\dot{q})\dot{q}+F(q)=u (6)

Where M, C and F are matrices that result from combining equations (4) and (5). For constrained systems, the following system of equations can be derived:

M(q)\dot{p}+C(q,p)p+F(q)=u (7)

\dot{q}=V(q)p (8)

Thus, depending on the number of state variables and constrains in the seat model, equations of motion (6) and equations of motion (7) and (8) are applicable for determining the torque required to achieve a desired motion for a seat system.

In the following, four seats 500-800 having different configurations are discussed in order of ascending complexity in order to illustrate the derivation of the state variables based on translation and rotation configuration of the seat and/or seat parts in general and local reference coordinates. The seats 500-800 represent four examples of numerous seat configurations in which the control method 20 and system of the disclosure can be implemented.

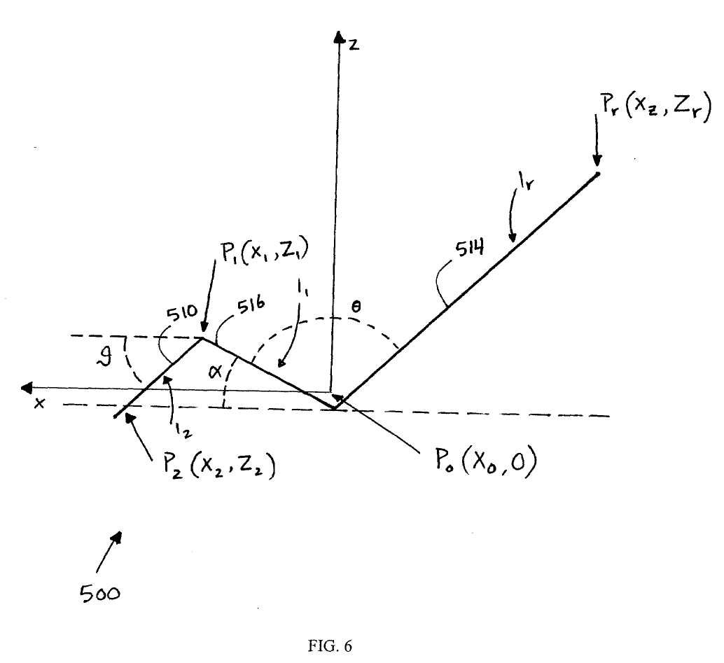

A first exemplary seat configuration is shown in FIG. 6. The seat 500 of FIG. 6 is capable of sliding horizontally independent of the rotation of the recliner 514. Additionally, the angle α of the seat pan 516 is constant. The motion of the seat 500 can be defined by the motion of three points P₁(x₁,z₁), P₂(x₂,z₂), Pᵣ(xᵣ,zᵣ), wherein P₀(x₀,z₀) is the center of the reference coordinate system (x,y,z) which is the pivot point between the seat pan 516 and the recliner 514 when the recliner 514 is at a 90-degree angle. The coordinate y is omitted in the following due to an assumption that the seats 500-800 or any part thereof is not moveable in the y direction (into the page in FIG. 6). Considering the lengths of the seat pan 516, the leg rest 510 and the recliner 514 to be l₁, l₂ and lᵣ, respectively, position of the points P₁, P₂ and Pᵣ in the coordinate system (x,y,z) can be expressed as:

x₁=x+l₁ cos α

z₁=l₁ sin α

x₂=x+l₁+l₂ cos φ

z₂=z₁+l₂ sin φ

xᵣ=x+lᵣ cos θ

zᵣ=lᵣ sin θ (9)

Where the angles α, θ and φ are shown in FIG. 6. Accordingly, the kinematics of the seat 500 can be characterized by five independent state variables: lᵣ, xᵣ, x₁ (or l₁), x₂ (or l₂), φ. Therefore, the seat 500 is a 5-DOF model.

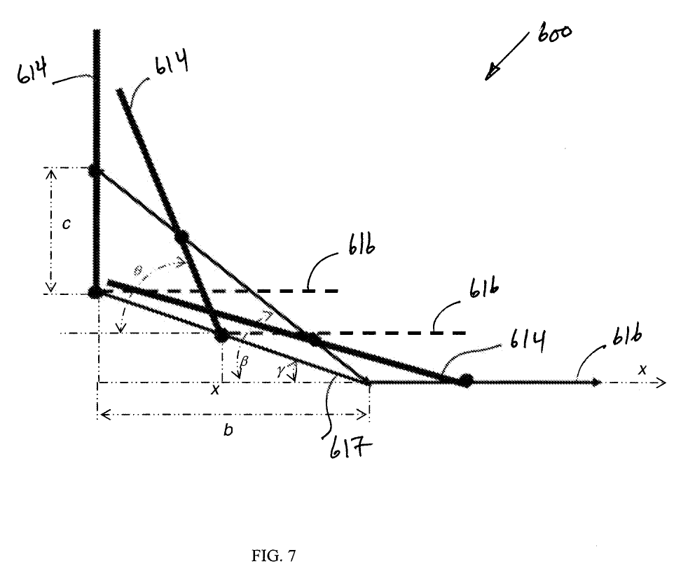

In the second example, the basic configuration of the seat is the same as shown in FIG. 6—the seat 600 is horizontally slidable along the x-axis. However, the rotation of the recliner 614 is coupled to the horizontal sliding of the seat pan 616 along the spreader 617, as shown in FIG. 7. Accordingly, the angle θ is a function of the coordinate x and not a separate degree of freedom. Hence, the seat of this example is a 3-DOF model.

The seat pan 616 is assumed horizontal and is shown with a dashed line in FIG. 7. The three possible positions of the recliner 614 are shown using the thick solid line. The point of connection of the seat pan 616 with the recliner 614 slides along an oblique spreader 617, having an angle γ with the horizontal axis. At the distance b from the origin of the coordinate system, the spreader 617 becomes horizontal. The point on the recliner 614, located at a distance c from the pivot slides along another oblique track, having an angle β with the horizontal axis. For the positions of the recliner 614 on the oblique portion of the spreader 617, the following equation can be derived:

$$\frac{c}{sin ( β - γ )} = \frac{b - {x}_{1}}{cos γ sin ( θ - β )} \qquad ( 10 )$$

For the recliner positions along the horizontal portion of the spreader 617 the equation is as follows:

$$\frac{c}{sin β} = \frac{{x}_{1} - b}{sin ( β - θ )} \qquad ( 11 )$$

Aside from the above constrains, the coordinates of the relevant points are calculated in the same way as in the first example seat 500.

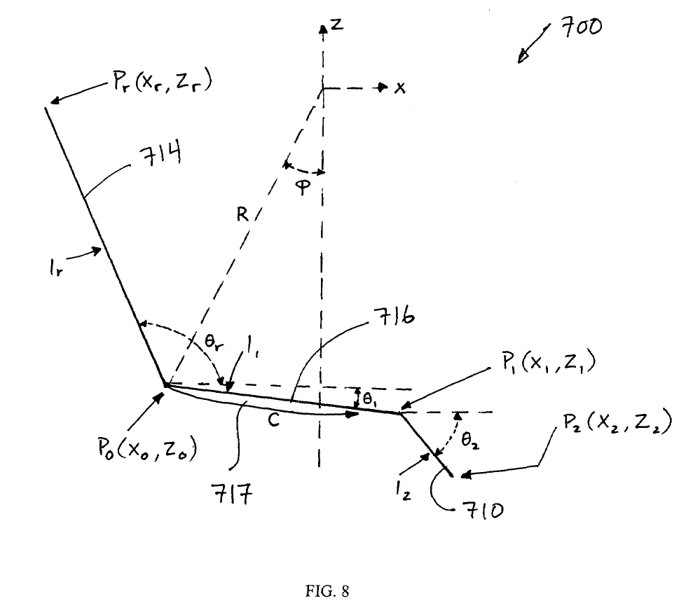

In the third example configuration, as shown in FIG. 8, the seat 700 includes a circular spreader 717. The rotation of the recliner 714 and the seat pan 716 are coupled to the sliding motion of the seat pan 716. Thus, the seat 700 is a 5-DOF model. The entire seat 700 slides along a spreader C, to which it is attached at the pivot point P₀. The spreader 717 has a circular configuration. However, the spreader 717 can have a more complex shape. The center of the coordinate system can be chosen at the center of the arc C to simply modeling of the seat 700. If the arc C is not circular, it can be defined with a function R(φ) representing the equation of the arc in polar coordinates (counter clockwise being positive).

As discussed above, the sliding motion of the seat pan 716 is coupled to pivoting of the recliner 714. Therefore, the angle θᵣ is a function of the coordinate φ and not a separate degree of freedom. Furthermore, the angle θ₁ can be a function of the coordinate φ. These functional dependencies can be defined based on the dimensional and structural relationships of the seat components. However, by applying general functional forms in the equations of motion, the resulting system of equations can be applicable to other types of seats.

As described above, the entire seat 700 slides along a spreader C, to which it is attached at the pivot point P₀. The seat 700 consists of three sections, namely a recliner 714 from which a headrest extends, an extendable seat pan 716, and the leg rest 710 from which a footrest extends. The equations for the coordinates of the relevant points are:

x₀=R cos φ

z₀=−R sin φ

xᵣ=x₀+lᵣ cos θᵣ

zᵣ=y₀+lᵣ sin θᵣ

xᵣ=x₀+lᵣ cos θ₁

zᵣ=y₀+lᵣ sin θ₁

x₂=x₁+l₂ cos θ₂

z₂=y₁+l₂ sin θ₂ (12)

If the arc C is not circular such that it is defined by the function R(φ), then the equation for z₀ changes to

z₀=R(φ)sin φ (13)

Since the variables θᵣ and θ₁ are functions of φ, the system is completely described by two angular variables and three linear variables and thus has 5 DOF.

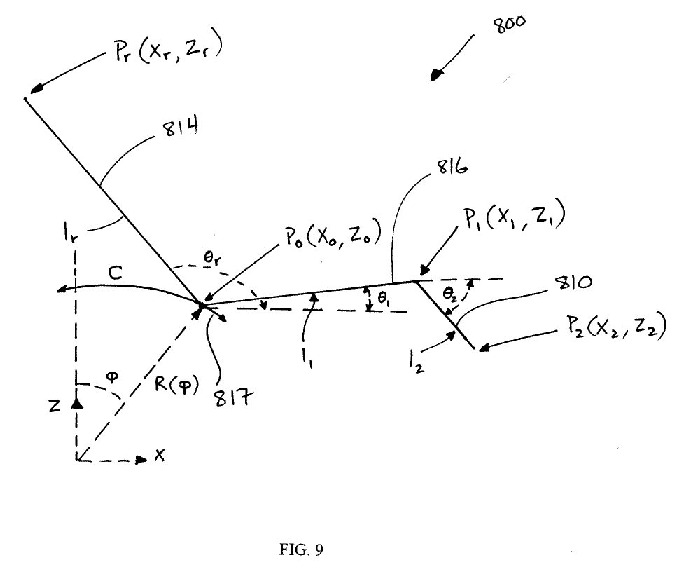

Referring to FIG. 9, where a fourth exemplary configuration of a seat 800 is shown, the recliner 814 rotates independently of the sliding motion of the seat pan 816. Therefore θᵣ is an additional DOF as compared to the seat 700. However, in order to make the model of FIG. 9 even more generic so as to be applicable to a variety of seat configurations, θ₁ can also be treated as an independent DOF. Therefore, the seat model of FIG. 9 includes 7 DOF.

In the above equations, extendable parts of the seat, such as extension of the head rest from the recliner and the extension of the foot rest from the leg rest are modeled as the recliner and the leg rest having variable length, respectively. For example, extending the headrest from the recliner varies the length lᵣ of the recliner in the above equations. However, in order to use methods of rigid body mechanics, it is necessary to define the kinematics of the seat by considering the extendable surfaces as separate bodies of constant length as opposed to variable-length bodies described above. In addition, the kinematics of each surface may be modeled in its own frame of reference (i.e., local coordinate system) as opposed to the global frame of reference as discussed above. Accordingly, physical characteristics of each surface, such as moment of inertia, length and mass can be defined and related to the surface by an index associated with that surface. Furthermore, the translation position of each surface can be denoted by x, the rotational position of each surface can be denoted by θ. Generalized velocities can be denoted w, if translations, and ω, if rotational.

If the kinematics of the seat are defined by considering the extendable surfaces as separate bodies, additional parameters may have to be defined to complete the seat model. For example, Table 1 shows moveable surfaces for the seat 500 of FIG. 6. The seat 500 includes three translational surfaces and two rotational surfaces. Each surface is driven by its own actuator, and therefore, each surface position is directly available to the control system once the surface positions are calibrated.

TABLE 1

| Number | Surface | Motion |
|---|---|---|
| 1 | Seat Pan | Translation |
| 2 | Leg Rest | Rotation |
| 3 | Foot Rest | Translation |
| 4 | Recliner | Rotation |
| 5 | Head Rest | Translation |

Table 2 shows moveable surfaces for the seat 600 of FIG. 7. The surfaces include two translational and two rotational surfaces.

TABLE 2

| Number | Surface | Motion | Control |
|---|---|---|---|
| 1 | Seat Pan | Translation | Actuator |
| 2 | Leg Rest | Rotation | Actuator |
| 3 | Foot Rest | Translation | Actuator |
| 4 | Recliner | Rotation | Coupled to the Seat Pan |

Unlike the recliner 514 of the seat 500, the recliner 614 is coupled to the seat pan 616 and is not driven by its own actuator. Therefore, the position of the recliner 614 is not directly available for measurements. Referring to FIG. 7, the angular position of the recliner 614 is θ₄, which is a function of x₁ as expressed by θ₄=ƒ(x₁). The exact form of this functional relation can be given by the following two equations:

$$\begin{matrix}f ( {x}_{1} ) = β + arcsin \frac{b - {x}_{1}}{c cos γ csc ( β - γ )} if {x}_{1} < b & ( 13 a ) \\ and & \\ f ( {x}_{1} ) = β + arcsin \frac{b - {x}_{1}}{c csc β} if {x}_{1} > b & ( 13 b )\end{matrix}$$

The parameters in these two equations are described above in relation to seat 600 of FIG. 7.

Table 3 shows the moveable surfaces for the seats 700 and 800 of FIGS. 8 and 9. The spreader 717,817 is treated as a “virtual” rigid arm of the length R having zero mass and zero moment of inertia. The seat pan 716,816 and the recliner 714,814 are then considered attached at the end of the virtual arm. The rotation angles of the seat pan 716,816 and the recliner 714,814 are functions of the angular position of the seat 800 on the spreader 717,817. These functions can be determined through experimentation and stored numerically in a table. The surfaces of the second approach are shown in Table 3.

TABLE 3

| Number | Surface | Motion | Control |
|---|---|---|---|
| 0 | Spreader | Rotation | Actuator |
| 1 | Seat Pan | Rotation | Coupled to the spreader |
| 2 | Seat Pan Extension | Translation | Actuator |
| 3 | Leg Rest | Rotation | Actuator |
| 4 | Foot Rest | Translation | Actuator |
| 5 | Recliner | Rotation | Coupled to the Spreader |

The angular position of the seat relative to the spreader can be denoted φ, and the corresponding angular velocity can be denoted ω. These two angles can be calculated from the position of the actuator, which drives the horizontal motion of the seat pan 716,816. The following additional parameters are also required for the virtual arm approach: radius of the spreader, R, coordinate of the trailing edge of the seat pan extension in the seat pan coordinate frame, and coordinate of the trailing edge of the footrest in the leg rest coordinate frame. As with seat 600 of FIG. 7, constrain equations θ₁=ƒ₁(φ) and θ₅=ƒ₂(φ) can be formulated to reduce the number of equations.

### Trajectory Planning

Once the equations of motion have been derived for a particular seat configuration, desired paths of movement, i.e., a desired trajectory, in generalized coordinates as a function of time can be determined. The desired trajectory allows the control system to control the motion of the seat along the desired trajectories subject to applicable control laws. Because the desired trajectories are based on planning certain motions of various seat components, actuator dynamics are do not have to be taken into account.

The desired trajectory can be defined by a point-to-point motion along a trajectory, where a generalized coordinate of a point is moved from the initial position q₀ (position at zero time) to the final position q_{f} (position at final time) in time period T such that the velocity is equal to zero at both initial and final point. The position of the point along the trajectory can be defined as a cubic polynomial function q*(t)

q*(t)=a₃t³+a₂t²+a₁t+a₀ (14)

and require that the following equations are satisfied:

q*(0)=q₀

q*(T)=q_{f}

\dot{q}*(0)=\dot{q}*(T)=0. (15)

By using polynomials, the constraint equations to find the coefficients of the polynomial can be consistently solved. Solving equations (14) and (15) yields:

$$q * ( t ) = \frac{2 ( {q}_{0} - {q}_{f} )}{{T}^{3}} {t}^{3} - \frac{3 ( {q}_{0} - {q}_{f} )}{{T}^{2}} {t}^{2} + {q}_{0} . \qquad ( 16 )$$

This is the only equation needed for the planning direct point-to-point motion. This equation defines the position as a function of time. By differentiating this equation, velocity and acceleration prifiels can be obtained.

The trajectory may include waypoints through which a part of the seat has to pass. The waypoints can be defined by q₁*, q₂*, . . . q_{N}* with N being the number of waypoints including the end points. When all motion is in the same direction, the cubic polynomial in the equation (14) can be replaced by the polynomial of the degree N+3:

$$q * ( t ) = {\sum }_{n = 0}^{N + 3} {a}_{n} {t}^{n} \qquad ( 17 )$$

The constraint q*(0)=q₀ forces a₀=q₀, and the constraint \dot{q}*(0)=0 forces a₁=0. The remaining coefficients can be found by solving the system of linear equations:

$${\sum }_{n = 1}^{N + 3} {a}_{n} {T}_{i}^{n} = {q}_{i}^{*} ( t ) , i = 1 … N \\ {\sum }_{n = 1}^{N + 3} {a}_{n} {T}^{n} = {q}_{f} \\ {\sum }_{n = 1}^{N + 3} {na}_{n} {T}^{n - 1} = 0 \qquad ( 18 )$$

The time intervals Tᵢ are found by dividing the total time proportionally to the distance among the segments:

$${T}_{i} = \frac{{q}_{i}^{*} - {q}_{0}}{{q}_{f} - {q}_{0}} T \qquad ( 19 )$$

If the motion starts in the reverse direction, then equation (14) can be used first to plan the reverse motion, except that time interval for the reverse motion is obtained as a proportional share of the total time:

$${T}_{1} = \frac{\vert {q}_{1}^{*} - {q}_{0} \vert}{\vert {q}_{f} - {q}_{1}^{*} \vert + \vert {q}_{1}^{*} - {q}_{0} \vert} T \qquad ( 20 )$$

T₁ is then used in place of T and q₁* is used in place of q_{f} in the equation (1a). Once the reverse motion is planned, the rest of the motion can be planned as forward motion, i.e., using the equation (17) and solving for the coefficients, except that number of waypoints is reduced by one. Any number of waypoints can be selected. However, the computational complexity of the above-described method can increase. Furthermore, by scaling the coordinates, the values of |q₀−q_{f}| and T can be of the same order of magnitude to avoid oscillatory behavior of the polynomial. Additionally, if one of the actuators moves considerably slower than the others, then in order to avoid the jerky movements of the seat, the entire motion planning computation can be repeated.

### Control Method and System

The control system determines the amount of torque required by the actuators to move each coordinate point of the seat along a planned trajectory. The control system then delivers the required torque by controlling the current flowing through the actuator armature. The control system can be based on classical control systems or modern control systems. One aspect of control method and system according to the present disclosure is discussed in the following. However, one of ordinary skill in the art will appreciate that any suitable control system can be used.

The control system can determine the vector of the generalized torques u* from the measurements of the generalized coordinates and the generalized velocities. As described above in relation to equations (14) and (17), q*(t) is the desired trajectory. The acceleration a_{q}(t) along the desired trajectory can be calculated by

a_{q}(t)=\ddot{q}*(t)+Kₚ(q*(t)−q(t))+K_{d}(\dot{q}*(t)−\dot{q}(t)) (21)

Equation (21) represents a proportional-derivative (PD) controller. The requited torque can then be calculated from:

u*=M(q)a_{q}+C(q,p)p+F(q) (22)

The equation for the resultant closed-loop system is:

\dot{p}=a_{q}(t) (23)

Equation (23) is a second-order linear differential equation. Thus, the resultant closed-loop control system is linearized and decoupled. The gains Kₚ and K_{d} can be determined by standard linear system design methods.

The torque is directly proportional to the current through the armature of the actuator:

u=KₘI (24)

where Kₘ is motor gain and I is the current. Therefore, in order to control the torque, it is necessary to control the actuator current, which is described by the standard differential equation:

$$L \frac{d I}{d t} + RI = V ( t ) - {E}_{back} ( t ) \qquad ( 25 )$$

This is a linear equation, where I is the function, R is the resistance, V is the voltage and E_{back} is the voltage created by the back or counter electromotive force (back EMF). Therefore, standard methods of the classical control theory can be used, such as the proportional controller:

V(t)=E_{back}(t)+kₚ[I(t)−u*(t)/Kₘ] (26)

wherein u*(t) is the torque computed from equation (22). The back EMF can be calculated from the measured actuator position by computing its velocity.

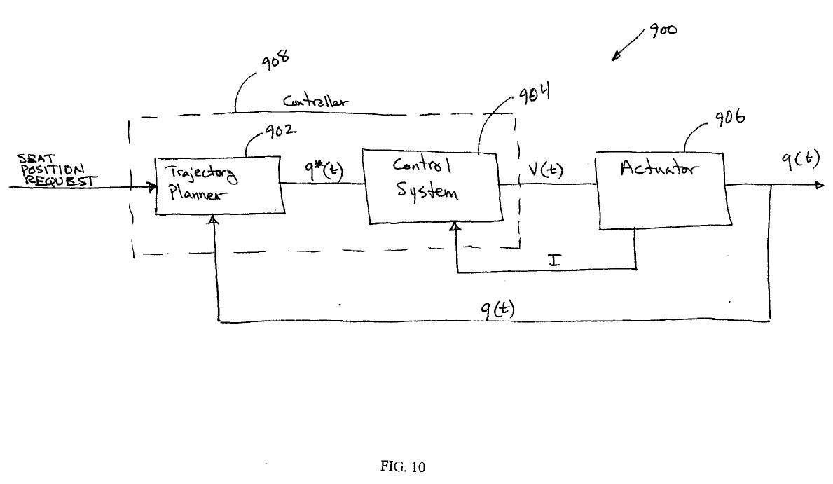

Referring to FIG. 10, a general block diagram for a control system 900 of the disclosure is shown. The control system 900 receives an input, which may be from a user of a seat through the PCU 104. The input includes a request by the user to move the seat from the current position of the seat or the first position to a second position or a desired position. Since the positions the seat at the first position and the second positions are known, a trajectory of the seat between the first position and the second position can be computed in a trajectory planner module 902 in accordance with the disclosure as described above. The trajectory computation results in q*(t), which provides desired positions along a trajectory as a function of time. The control system 900 includes a control module 904, which receives q*(t) as input and determines the voltage as a function of time V(t) that results in a torque output of each actuator to move the seat along the trajectory. The control module 904 may be based on any type of classical control system, modern control system, neural network algorithms, genetic optimization algorithms, fuzzy logic, and other methods that are known to those of ordinary skill in the art for using an error in position of the seat to move the seat toward reducing the error, i.e., keep the seat on the trajectory. The exemplary PD control system discussed above is such a control system, which is based on classical control theory. The actuator(s) 906 receive the voltage from the control module 904 and move the seat an actual trajectory q(t). The actual trajectory can be fed back to the trajectory planning module 902 and/or the control module 904 (not shown) to calculate a new trajectory based on any errors between q*(t) and q(t). The control system issues a new voltage based on the new trajectory to produce a desired torque with the actuator. The block diagram of FIG. 10 represents an example of the control method and system of the disclosure. The trajectory planner 902 and the control module 904 can be components of a controller 904.

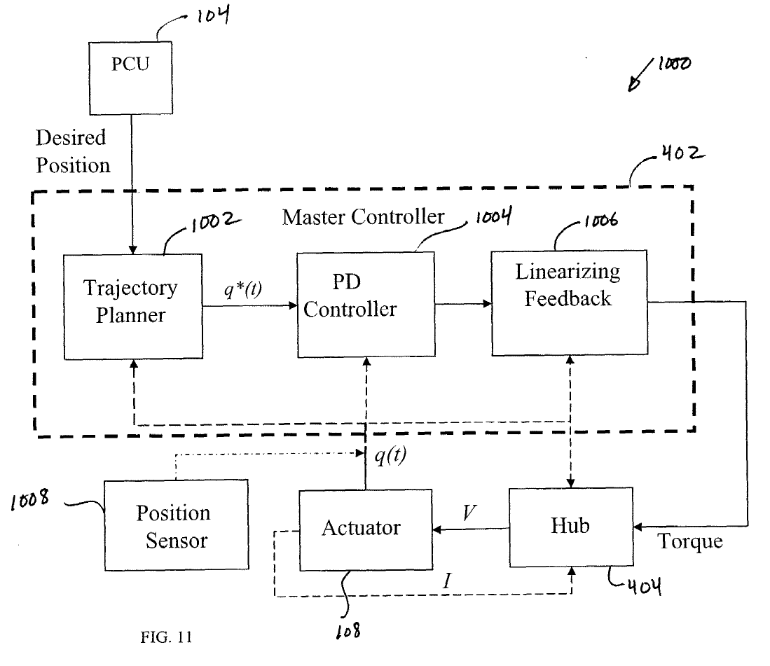

Referring to FIG. 11, where arrows with a solid line represent commands and arrows with a dashed line represent feedback, a block diagram for a control method and system 1000 as applied to the seat operating system of FIG. 5 is shown. The main controller 402 (shown in FIG. 11 as the master controller) can perform the trajectory planning, the torque computation and control functions. The main controller 402 includes a trajectory planner module 1002, which receive a position request from the PCU 104. Based on the seat position request, the trajectory planner 1002 computes the desired trajectory q*(t) for the seat to achieve the desired position. The control system 1002 includes a PD controller module 1004 and a linearizing feedback module 1006, which carry out the torque computation as described above. The linearizing feedback module 1006 can also compute the matrices M, C, F, and V of equation (6) (matrix V is computed if constrains are present) followed by the computation from the equation (22) of the torque that each actuator must apply to the appropriate seat part. The hub controllers 404 receive the computed torque from the linearizing feedback module 1006 and compute a voltage required to drive the corresponding actuators to produce the computed torque. The current of the actuators 108 can be fed back to the hub controllers 404 so that the required voltage can be computed in response to changes in the actuator current and position. The position q(t) along the trajectory is fed back by a position sensor (not shown) or the actuator 108 to the main controller 402 so that a new trajectory can be calculated if errors in the actual position relative to the desired position are present. The PD controller module 1004 and the linearizing feedback module 1006 issue a new torque command to the hub controller 404.

The actual position of the seat may be determined by position sensors 1008 and fed back to the master controller 402 as shown in FIG. 11 with a dashed line. Alternatively, the position of each actuator, which is representative of the actual position of the seat may be fed back to the master controller 402 as shown in FIG. 11 with a solid line.

The main controller 402 can keep track of the current position of each actuator. The main controller 402 can also include a motion planning module (not shown) that implements the motion planning equations (16) and (17) for each actuator. The motion planning module can calculate the desired target position of each actuator based on the input from the passenger control unit 104. The motion-planning module can reference or receive the current position of each actuator from the main controller memory (not shown). The time interval required for the seat to complete its motion can be either predetermined or set by the user based on the user's preferences. Once this time interval is determined or set, it can remain the same value for all of the actuators. The output of the motion planning module can be the reference position of each actuator computed in real time.

The main controller 402 can include a separate controller module (not shown) in order to implement the control method or algorithm for each actuator, such as the PD controller equation (21). The controller module can accept as input the current position of each actuator and the position of each actuator computed by the motion-planning module. Gains for the control algorithm or method can be determined for each actuator and stored in the main controller memory. The output of the controller module can be a set of functions of time, one for each actuator.

The main controller can also include a computational module (not shown) for implementing real-time computation of the matrices M, C, F, and V (matrix V is computed if constrains are present) from the positions of the actuators. The computations module can receive as input the current positions of all the actuators. The computational module can include a switch for switching from one seat model to another.

The main controller can include a separate module (not shown) to implement the real-time computation of the torque using the equation (22) and referencing the elements of the matrices M, C, F, and V.

The hub controllers 404 can compute in real time, using the equation (26), the voltage needed to produce the actuator armature current needed for the actuator to deliver the amount of torque computed by the main controller 402. The proportional gain for the voltage computation by the hub controller 404 can be user-programmable for each actuator.

The control method and system of the present disclosure is described in the context of vehicle seats, and in particular in the context of airplane seats. However, one of ordinary skill in the art will appreciate that the disclosure is applicable to any type of powered seat having one or multiple moveable surfaces. For example, the control method and system of the disclosure can be applied to reclining or message chairs designed for personal use.

In summary, the disclosure generally relates to an improved control method and system for a vehicle seat. While certain exemplary embodiments have been described above in detail and shown in the accompanying drawings, it is to be understood that such embodiments are merely illustrative of and not restrictive of the broad disclosure. In particular, it should be recognized that the teachings of the disclosure apply to a wide variety of systems and processes. It will thus be recognized that various modifications may be made to the illustrated and other embodiments of the disclosure described above, without departing from the broad inventive scope thereof. In view of the above it will be understood that the disclosure is not limited to the particular embodiments or arrangements disclosed, but is rather intended to cover any changes, adaptations or modifications which are within the scope and spirit of the disclosure as taught herein.

What is claimed is:

1. A method of controlling a vehicle seat, the method comprising:
determining a desired trajectory between a first position of the seat and the second position of the seat;
determining a torque to move the seat along the desired trajectory with a velocity profile along the trajectory; and
applying the torque to the seat to move the seat between the first position and a second position along the desired trajectory.

2. The method of claim 1, further comprising sensing a position of the seat along the trajectory, wherein determining the desired trajectory is responsive to at least the sensed position of the seat.

3. The method of claim 1, further comprising sensing a position of the seat along the desired trajectory, wherein determining the torque is responsive to at least the sensed position of the seat.

4. The method of claim 1, further comprising operating an actuator to produce the torque, and sensing a torque output of the actuator, wherein operating the actuator is responsive to at least the torque output of the actuator.

5. The method of claim 1, wherein determining the torque comprises:
sensing a position corresponding to an actual position of the seat;
determining an error in position defined by a difference between the sensed position and a corresponding position of the seat along the determined trajectory;
determining a torque to reduce the error.

6. The method of claim 1, wherein determining of the torque comprises computing the torque with a proportional-derivative controller in cascade with the linearizing feedback.

7. A method of controlling a vehicle seat, the method comprising:
receiving a request to move the seat from a first position to a second position;
sensing a position corresponding to an actual position of the seat;
determining a trajectory between the first position and the second position, the trajectory comprising a plurality of seat positions;
determining a torque to move the seat from the first position along the trajectory toward the second position based on any difference between the sensed position and a one of the plurality of seat positions along the trajectory corresponding to the sensed position; and
applying the torque to the seat to move the seat.

8. The method of claim 7, wherein determining the trajectory is responsive to at least the sensed position.

9. The method of claim 7, further comprising operating an actuator to produce the torque, and sensing a torque output of the actuator, wherein operating the actuator is responsive to at least the torque output of the actuator.

10. The method of claim 7, wherein determining the torque comprises computing the torque with a proportional-derivative controller in cascade with the linearizing feedback.

11. A control system for a vehicle seat comprising:
at least one sensor configured to provide a sensed position corresponding to an actual seat position;
a main controller configured to receive a request for a second seat position different from a first seat position, the controller configured to determine a trajectory for the seat between the first seat position and the second seat position; and
wherein the main controller is configured to determine a torque to move the seat along the trajectory toward the second seat position based on any difference between the sensed position and a seat position along the trajectory corresponding to the sensed position.

12. The control system of claim 11, further comprising:
at least one hub controller coupled to the main controller; and
at least one actuator coupled to the hub controller;
wherein the hub controller is configured to operate the actuator based on the determined torque from the main controller.

13. The control system of claim 12, wherein an output current of the actuator is fed back to the hub controller.

14. The control system of claim 11, wherein the main controller comprises:
a trajectory planning module configured to determine the trajectory; and
a control module configured to receive the trajectory and determine the torque.

15. The control system of claim 14, wherein the control module comprises a proportional-derivative controller in cascade with the linearizing feedback.

16. A vehicle seat comprising:
a seat comprising at least one moveable part and configured to be moveable between a plurality of seat positions;
at least one sensor configured to provide a sensed position corresponding to an actual seat position;
an actuator coupled to the at least one moveable part and configured to move the seat between the plurality of seat positions; and
a main controller configured to receive a request for a second seat position different from a first seat position, the controller configured to determine a trajectory for the seat between the first seat position and the second seat position;
wherein the main controller is configured to operate the actuator to move the seat along the trajectory toward the second seat position based on any difference between the sensed position and a seat position along the trajectory corresponding to the sensed position.

17. The vehicle seat of claim 16, further comprising at least one hub controller coupled to the main controller, wherein the main controller is configured to determine a torque to operate the actuator, and wherein hub controller is configured to operate the actuator based on the determined torque from the main controller.

18. The vehicle seat of claim 17, wherein an output current of the actuator is fed back to the hub controller.

19. The vehicle seat of claim 16, wherein the main controller comprises:
a trajectory planning module configured to determine the trajectory; and
a control module configured to receive the trajectory and determine a torque for operating the actuator.

20. The vehicle seat of claim 19, wherein the control module comprises a proportional-derivative controller.

21. The vehicle seat of claim 16, wherein the sensed position is an actual position of the seat in cascade with the linearizing feedback.

22. The vehicle seat of claim 16, wherein the sensed position is an actual position of the actuator.
